(19) United States
(12) Patent Application Publication
(10) Pub. No.: US 2011/0320937 A1
(43) Pub. Date: Dec. 29, 2011

(54) EDITING APPARATUS, EDITING METHOD PERFORMED BY EDITING APPARATUS, AND STORAGE MEDIUM STORING PROGRAM

(75) Inventor: Noriyuki Yamamoto, Yokohama-shi (JP)

(73) Assignee: CANON KABUSHIKI KAISHA, Tokyo (JP)

(21) Appl. No.: 13/113,764

(22) Filed: May 23, 2011

(30) Foreign Application Priority Data
Jun. 25, 2010 (JP) 2010-145523

(51) Int. Cl. G06F 17/24

(52) U.S. Cl. 715/256; 715/255

(57) ABSTRACT

A template in which an object is editable is acquired, and it is determined whether the size of an object targeted for editing is different from a corresponding object size defined in the template. If it is determined that the sizes are different, the acquired object is modified in accordance with the size defined in the template and embedded into the template. As a consequence of the object being embedded into the template, a difference between the size defined in the template and the size of the acquired object is calculated, and an evaluation based on the difference is output.

### BACKGROUND OF THE INVENTION

1. Field of the Invention

The present invention relates to an editing apparatus and an editing method for performing editing processing, and a storage medium for storing a program.

2. Description of the Related Art

There is known method for generating desired document data by embedding an object into a template in which a region for embedding an object having an image or text attribute in a document has been defined in advance. In the case where there are multiple different templates, document data is generated by selecting the desired template and embedding an object into the template.

For selection of templates, for example, one or more keywords are given in advance to each template. For instance, in the case of embedding an image object, a template given with a keyword relevant to imaging information about that image or the like is selected (Japanese Patent Laid-Open No. 2003-046916).

However, in Japanese Patent Laid-Open No. 2003-046916, in the case where multiple templates are selected and displayed in a list after having embedded an object, how the object has been embedded in the templates is not recognized. That is, in the case of selecting and listing multiple templates that match the keyword condition, how much processing (for example, size reduction and clipping) each embedded object has undergone is not particularly considered. If the degree of processing each object has undergone is large, it can cause a reduction in the display quality of an original object. Accordingly, it is impossible for the user to select, from the list displayed, an appropriate template that has the desired layout and maintains display quality.

### SUMMARY OF THE INVENTION

An aspect of the present invention is to eliminate the above-mentioned problems with the conventional technology. The present invention provides an editing apparatus, an editing method, and a storage medium for storing a program, that improve the usability for the user when editing an object.

The present invention in its one aspect provides an editing apparatus comprising: a storage unit configured to store a plurality of templates in each of which a pattern used in editing at least one object and a size of each object is defined; an object acquiring unit configured to acquire an object targeted for editing; a template acquiring unit configured to acquire, from the storage unit, a template in which the object acquired by the object acquiring unit is editable; a determination unit configured to determine whether a size of the object acquired by the object acquiring unit is different from the size defined in the template; an embedding unit configured to, in a case where the determination unit determines that the size of the object acquired by the object acquiring unit is different from the size defined in the template, modify the object in accordance with the size defined in the template and embed the object into the template; a calculation unit configured to calculate a difference between the size defined in the template and the size of the object acquired by the object acquiring unit, as a consequence of the embedding unit embedding the object into the template; and an output unit configured to output an evaluation based on the difference calculated by the calculation unit.

The present invention improves the usability for the user when editing an object.

Further features of the present invention will become apparent from the following description of exemplary embodiments with reference to the attached drawings.

### BRIEF DESCRIPTION OF THE DRAWINGS

FIG. 1 is a diagram showing the configuration of an editing apparatus according to an embodiment of the present invention.

FIG. 2 is a diagram showing functional blocks in the editing apparatus.

FIG. 3 is a flowchart showing a procedure of processing for displaying a list according to the embodiment.

FIG. 4 is a flowchart showing a procedure of modifying processing performed on image data and processing for embedding the image data into a template.

FIG. 5 is a flowchart showing a procedure of modifying processing performed on text data and processing for embedding the text data into a template.

FIGS. 6A and 6B are diagrams showing examples of templates stored in a template database.

FIG. 7 is a diagram showing an example of text and an image to be embedded into a template.

FIG. 8 is a diagram showing an example in which image data is changed in size and trimmed in accordance with an image embedding region of a template.

FIGS. 9A, 9B, and 9C are diagrams for illustrating a method for calculating a font size.

FIG. 10 is a diagram showing an example of a document that has undergone layout editing processing.

FIG. 11 is a diagram showing another example of a document that has undergone layout editing processing.

FIG. 12 is a diagram showing an example in which documents that have undergone layout editing processing are displayed in a list.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are required with respect to the means to solve the problems according to the present invention. Note that the same reference numerals have been given to constituent elements that are the same, and descriptions thereof will not be given.

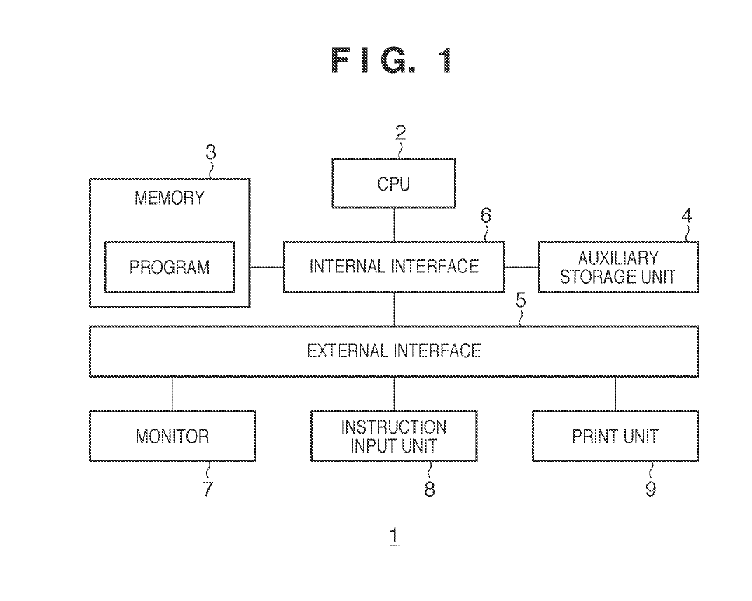

FIG. 1 is a diagram showing a configuration of an editing apparatus 1 according to an embodiment of the present invention. The editing apparatus 1 performs layout editing processing to lay out an object in document data. The editing apparatus 1 includes a CPU 2, a memory 3, an auxiliary storage unit 4, an external interface 5, an internal interface 6, a monitor 7, an instruction input unit 8, and a print unit 9. As shown in FIG. 1, the CPU 2, the memory 3, the auxiliary storage unit 4, and the external interface 5 are connected to one another via the internal interface 6. Furthermore, the monitor 7, the instruction input unit 8, and the print unit 9 are connected to one another via the external interface 5.

The CPU 2 controls the overall system by giving instructions to various units shown in FIG. 1 and performing various types of data processing and information processing, for example. The CPU 2 also executes processing shown in the flowcharts discussed below. The auxiliary storage unit 4 is, for example, a hard disk drive (HDD) that has stored programmed programs in advance. The CPU 2 controls various units by executing programs stored in the auxiliary storage unit 4 and loaded in the memory 3. The flowcharts discussed later show the procedures of processing performed by the CPU 2 loading a program stored in the auxiliary storage unit 4 into the memory 3 and executing the loaded program. The monitor 7 is, for example, a liquid crystal monitor or a CRT monitor that provides operation instructions to the user or displays the result of operation. The instruction input unit 8 is, for example, a keyboard or a pointing device that accepts instructions or input from the user. The print unit 9 is, for example, a printer.

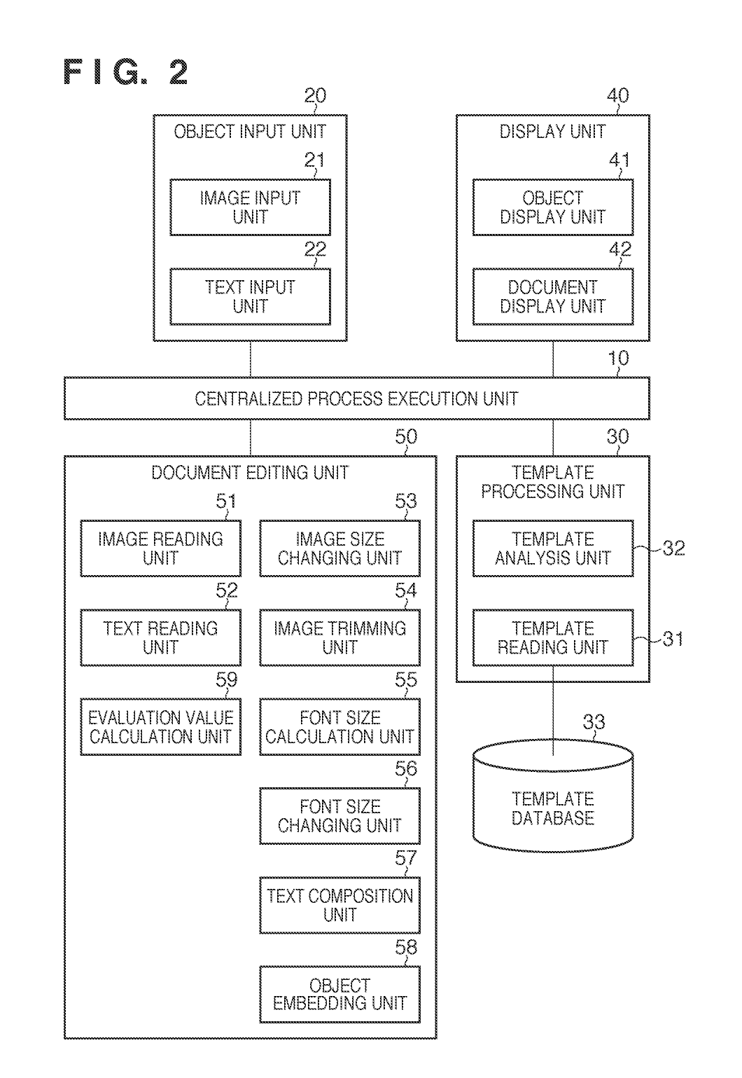

FIG. 2 is a diagram showing functional blocks in the editing apparatus 1. In order to implement the layout editing processing function of the editing apparatus 1, a centralized process execution unit 10 performs centralized management such as management of data transfer for performing various types of processing, control of various units, and execution of processing. An object input unit 20 inputs an object to be embedded into a template. An image input unit 21 inputs an image object (image data) to be embedded into a template. A text input unit 22 inputs a text object (text data) to be embedded into a template.

A template processing unit 30 processes a template into which an object is embedded. A template database 33 stores data of multiple templates in which a pattern for laying out an object(s) and the size of each object have been defined in advance. A template reading unit 31 reads a necessary template from the template database 33. A template analysis unit 32 analyzes such a read template.

A display unit 40 displays an input object or a document that has undergone layout editing processing according to the present embodiment. An object display unit 41 displays an object input by the object input unit 20. A document display unit 42 displays a document that has undergone layout editing processing according to the present embodiment.

A document editing unit 50 reads data of a template or an input object into the memory 3 and performs various types of editing processing. An image reading unit 51 reads image data input by the image input unit 21 into the memory 3. A text reading unit 52 reads text data input by the text input unit 22 into the memory 3. An image size changing unit 53 changes the size of image data. An image trimming unit 54 performs trimming processing on image data. A font-size calculation unit 55 calculates an appropriate font size of text data. A font-size changing unit 56 changes the font size of text data. A text composition unit 57 performs composition processing for embedding text data into a template. An object embedding unit 58 embeds image data or text data into a template. An evaluation-value calculation unit 59 calculates an evaluation value in accordance with the degree of modifying that has been performed on image data or text data.

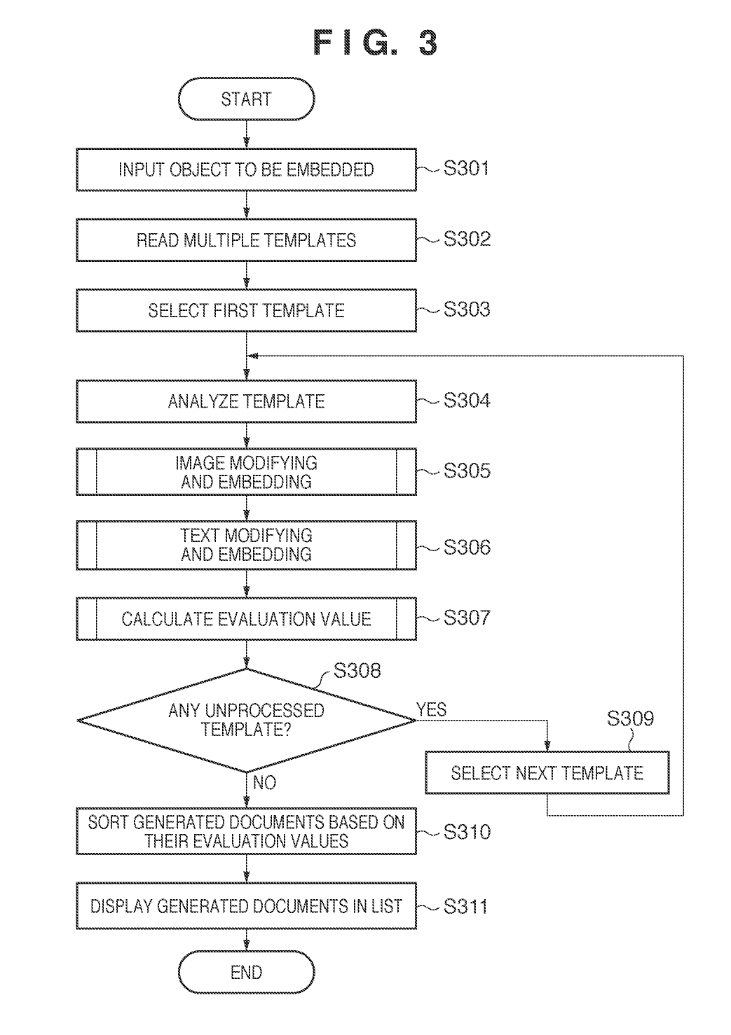

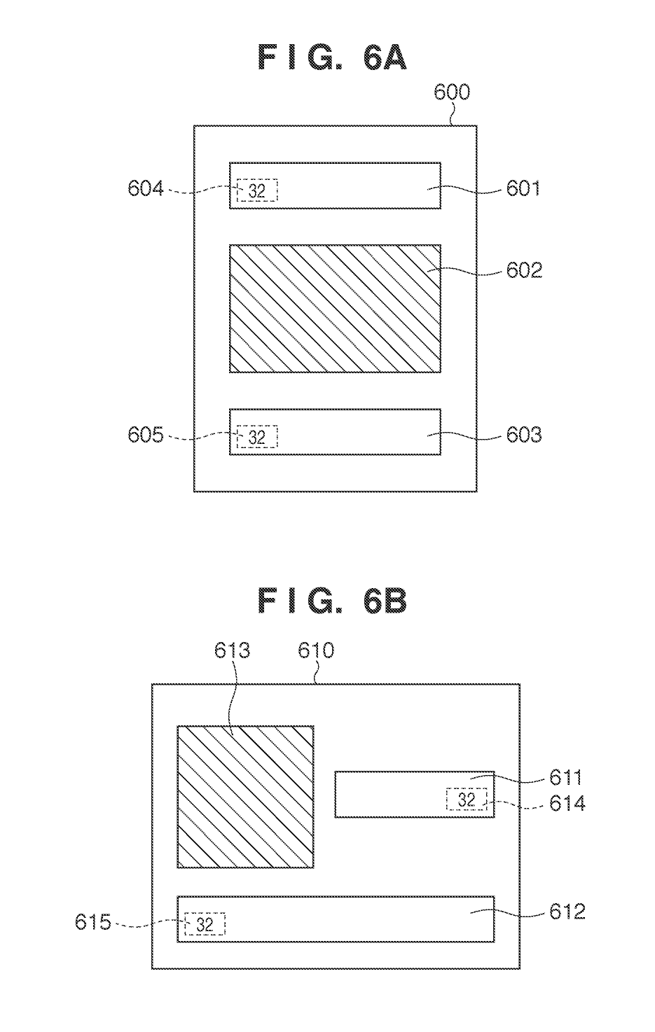

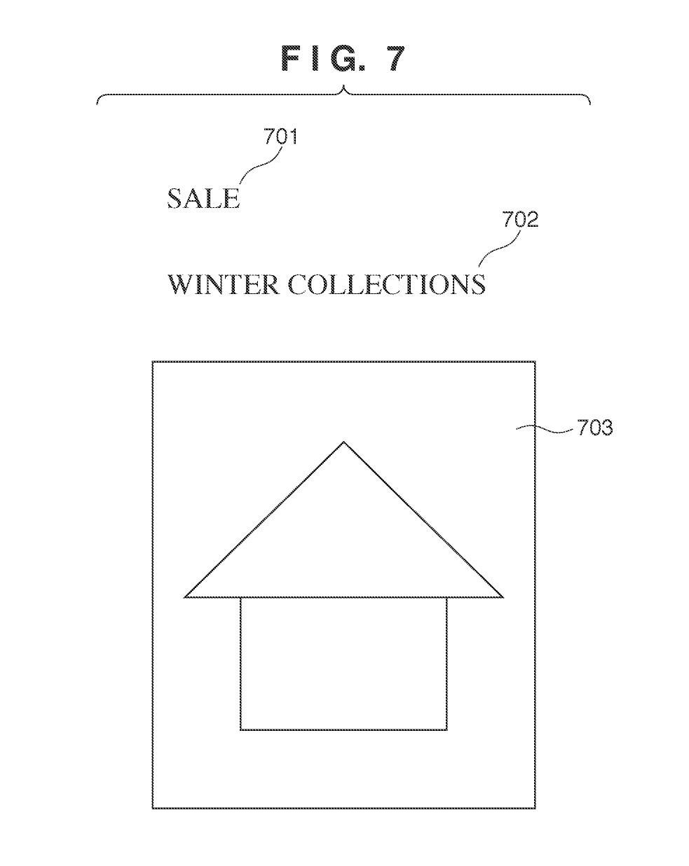

FIG. 3 is a flowchart showing the procedure of processing for generating documents through layout editing processing, in which an object is embedded into multiple templates, and displaying the documents in a list. The following is a description of the case where text 701, text 702, and an image 703 as shown in FIG. 7 are embedded into templates 600 and 610 as shown in FIGS. 6A and 6B. It is assumed that at least a single piece of text data or image data is embedded into a template, and the number of data pieces to be embedded is not particularly limited. Note that the centralized process execution unit 10 that always performs centralized management, such as management of data transfer for performing various types of processing and execution of processing performed by various control units, has been omitted from the description of this processing. In step S301, the object input unit 20 acquires at least one object targeted for editing from a document (an example of object acquisition). In the present embodiment, the text 701, the text 702, and the image 703 as shown in FIG. 7 are acquired. The acquired objects are displayed by the object display unit 41. In step S302, multiple templates are read. In the present embodiment, the two templates 600 and 610 as shown in FIGS. 6A and 6B are read from the template database 33 by the template reading unit 31. In step S303, one of the two templates that have been read is selected as a target of editing processing. When reading templates in step S302, a table for acquiring templates from the template database 33 may be prepared in advance. For example, the table associates, for each template including objects, the number of objects having an image attribute in the template, the number of objects having a text attribute in the template, and a file path representing a storage location for referencing the template. Templates that match the number of objects having the image attribute and the number of objects having the text attribute, which have been acquired in step S301, are acquired as templates into which the objects can be laid out (an example of template acquisition).

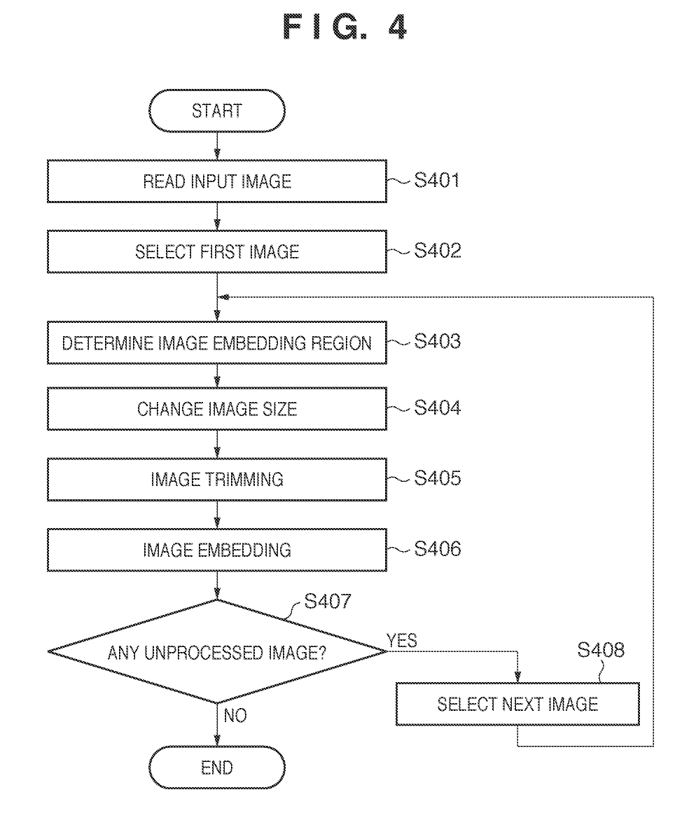

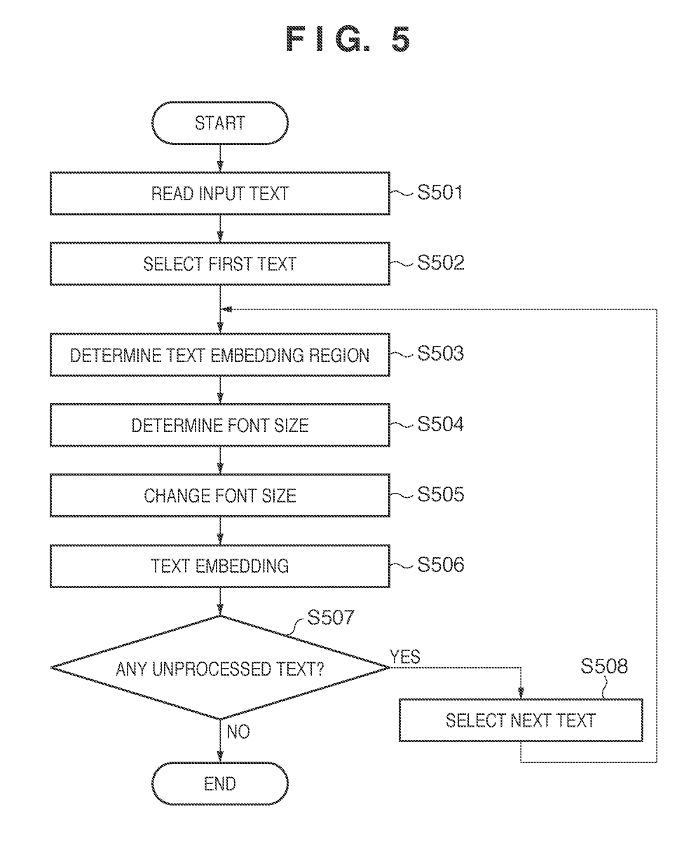

In step S304, the template analysis unit 32 analyzes the template selected in step S303. For example, the template 600 is detected as including a text embedding region 601, a font size 604, a text embedding region 603, a font size 605, and an image embedding region 602 as shown in FIG. 6A. Here, the font size 604 is set as the attribute of the text embedding region 601, and the font size 605 is set as the attribute of the text embedding region 603. Furthermore, the template 610 is detected as including a text embedding region 611, a text embedding region 612, and an image embedding region 613. Here, a font size 614 is set as the attribute of the text embedding region 611, and a font size 615 is set as the attribute of the text embedding region 612. In step S305, image data modifying and embedding of image data into the template are performed. The details thereof will be described with reference to FIG. 4. In step S306, text data modifying and embedding of the text data into the template are performed. The details thereof will be described with reference to FIG. 5. Embedding image data and text data into each template produces a document data piece.

In step S307, an evaluation value is calculated. The details thereof will be discussed later. In step S308, it is determined whether or not there is an unprocessed template. If it has been determined that there is an unprocessed template, the procedure proceeds to step S309. In step S309, the next template is selected as a target of editing processing, and the procedure returns to step S304. On the other hand, if it has been determined that there is no unprocessed template, the procedure proceeds to step S310. In step S310, the generated document data pieces are sorted by the document display unit 42, based on their evaluation values calculated in step S307. In step S311, the generated document data pieces are displayed by the document display unit 42 in the sorted order obtained in step S310.

FIG. 4 is a flowchart showing a procedure of the modifying processing performed on image data and the processing for embedding the image data into a template. The following description takes the example of the case where the image 703 is embedded into the template 600. First, the image 703 input by the image reading unit 51 is read in step S401. In step S402, a single piece of image data is selected as a target of modifying processing. In the present example, the image 703 is selected. In step S403, the image embedding region 602 shown in FIG. 6A is determined as a region for embedding the image 703, based on information of the template analyzed in step S304. Then, the image size changing unit 53 changes the size of the image data in step S404, and the image trimming unit 54 performs trimming on the image data in step S405.

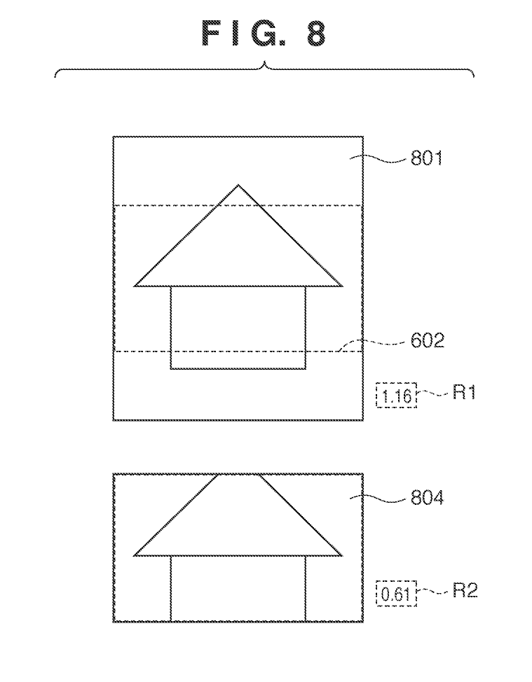

Here, a method for changing the image data size of the image 703 and trimming the image 703 in accordance with the image embedding region 602 of the template 600 is described with reference to FIG. 8. In the present embodiment, the aspect ratio R1 of the image 703 (for example, 1.16) is greater than the aspect ratio R2 of the image embedding region 602 (for example, 0.61). Accordingly, the size of the image 703 is changed while retaining the aspect ratio R1 thereof so that the width of the image 703 matches the width of the image embedding region 602. An image 801 shown in FIG. 8 is obtained by changing the size of the image 703 in accordance with the image embedding region 602. In the case where the aspect ratio R1 is less than or equal to the aspect ratio R2, the size of the image 703 is changed so that the height of the image 703 matches the height of the image embedding region 602.

Next, the image 703 is subjected to trimming processing (clipping) performed in accordance with the image embedding region 602. An image 804 shown in FIG. 8 is obtained by, for example, centering and superimposing the image embedding region 602 over the image 703 and trimming a portion of the image 703 that lies outside the image embedding region 602.

In step S406, the image 804 whose size has been changed and which has been trimmed is embedded into the template 600 by the object embedding unit 58. In step S407, it is determined whether or not there is unprocessed image data. If it has been determined that there is unprocessed image data, the procedure proceeds to step S408. In step S408, the next piece of image data is selected as a target of modifying processing and the procedure returns to step S403. On the other hand, if it has been determined that there is no unprocessed image data, this procedure ends.

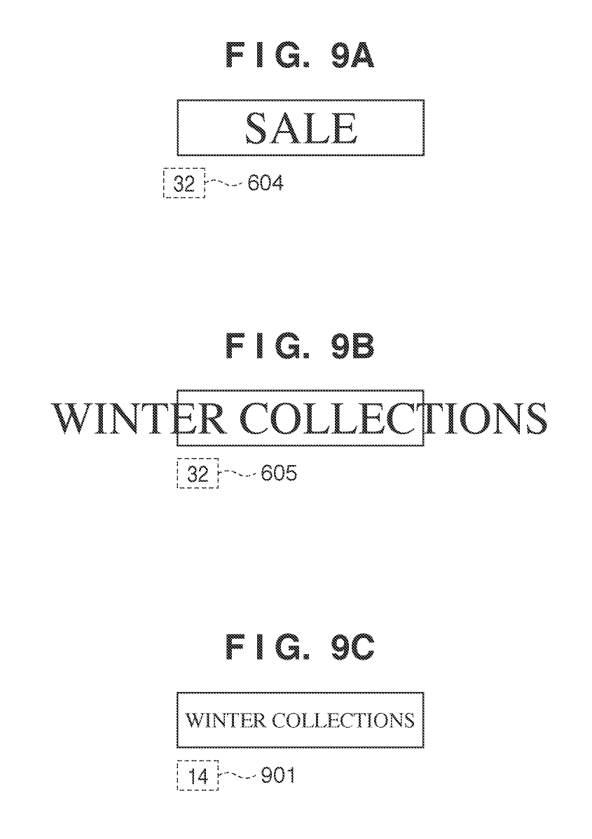

FIG. 5 is a flowchart showing a procedure of the modifying processing performed on text data and the processing for embedding text data into a template. The following description takes the example of the case where the text 701 and the text 702 are embedded into the template 600. First, in step S501, the text 701 and the text 702 input by the text reading unit 52 are read. In step S502, a single piece of text data is selected as a target of modifying processing. In the present example, the text 701 is selected. In step S503, the text embedding region 601 shown in FIG. 6A is determined as a region for embedding the text 701, based on information of the template analyzed in step S304. In step S504, an appropriate font size is calculated by the font-size calculation unit 55. The method for calculating the font size will be described later with reference to FIGS. 9A to 9C. In step S505, the font size is changed by the font-size changing unit 56. In step S506, text composition is performed by the text composition unit 57, and the composed text data is embedded into the text embedding region 601 of the template 600 by the object embedding unit 58. If it has been determined in step S507 that there is unprocessed text data, the procedure proceeds to step S508. In step S508, the next piece of text data is selected as a target of modifying processing and the procedure returns to step S503. On the other hand, if it has been determined that there is no unprocessed text data, this procedure ends.

Next is a description of the method for changing the font size, with reference to FIGS. 9A to 9C. In the case where the text 701 is embedded into the text embedding region 601 shown in FIG. 6A, it is determined whether or not the text 701 fits in the text embedding region 601, based on the font size 604 set for the text embedding region 601 of the template 600. If the text 701 fits in the text embedding region 601 with the font size 604 as shown in FIG. 9A, the font size 604 is determined as-is as an appropriate font size of the text 701.

In the case of embedding the text 702 into the text embedding region 603, it is determined whether or not the font size of the text 702 is larger than the font size of the text embedding region 603, based on the font size 605 set for the text embedding region 603. If it has been determined that the font size of the text 702 is larger than the font size 605 of the text embedding region 603 as shown in FIG. 9B, the font size of the text 702 is reduced to a size smaller than or equal to the font size of the text embedding region 603. FIG. 9C is a diagram showing that result. In other words, the font size obtained by reducing the font size of the text 702 to such an extent that the text 702 fits in the text embedding region 603 is determined as an appropriate font size 901 of the text 702. On the other hand, if it has been determined that the font size of the text 702 is smaller than or equal to the font size of the text embedding region 603, the font size of the text 702 is not changed. Alternatively, in the case where it has been determined that the font size of the text 702 is smaller than or equal to the font size of the text embedding region 603, the font size of the text 702 may be increased.

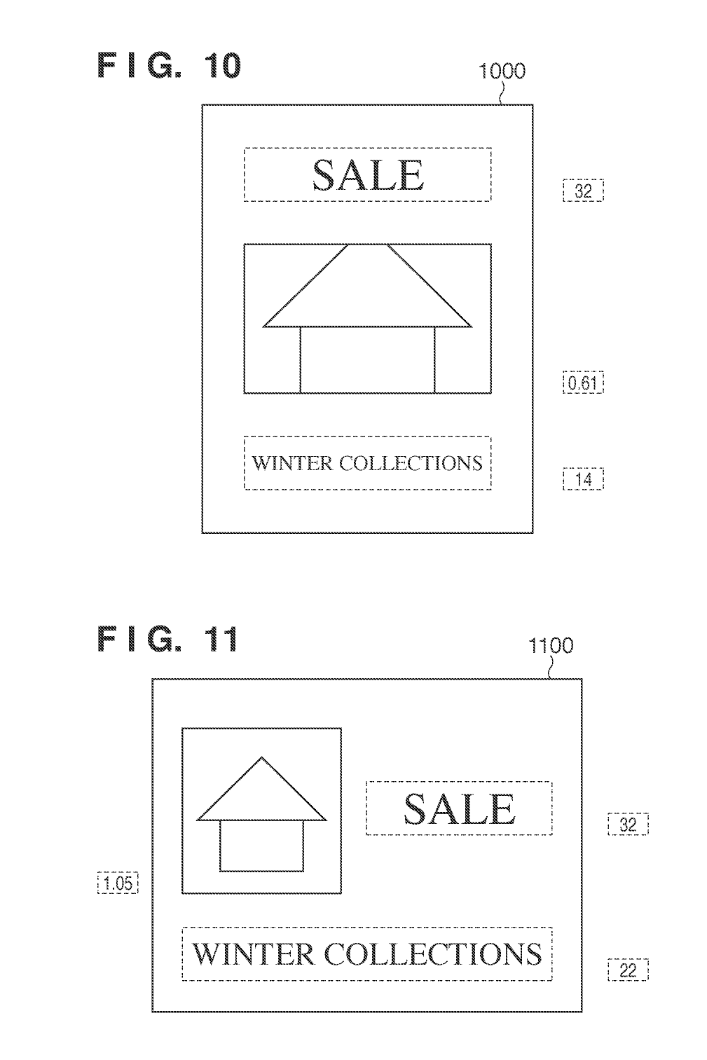

By embedding the text 701, the text 702, and the image 703 into the template 600 through the above-described processing, a document 1000 is generated as shown in FIG. 10. Furthermore, a document 1100 is generated as shown in FIG. 11 by embedding the text 701, the text 702, and the image 703 into the template 610.

Next is a description of the method for calculating an evaluation value. The evaluation value is calculated for each of the documents generated as described above (the documents 1000 and 1100), based on how object data has been modified and embedded into the template in the course of generating the document. In the present embodiment, the method for calculating the evaluation value is not limited to the one described below as long as the evaluation value is calculated based on how object data has been modified and embedded into the template.

If Rp is the aspect ratio of an image represented by image data and Rs is the aspect ratio of an image embedding region in a template, a ratio EP representing the degree of modifying performed when trimming the image data in accordance with the image embedding region is calculated from Equation (1).

EP=Rs/Rp, where Rp>Rs,

EP=Rp/Rs, where Rp<Rs, and

EP=1.0, where Rp=Rs

Furthermore, if Ft is the font size set as the attribute of a text embedding region in a template and Fs is the font size at which text data fits in the text embedding region, a ratio ET representing the degree of modifying performed on the text data is calculated from Equation (2).

ET=Fs/Ft, where Ft>Fs,

ET=Ft/Fs, where Ft<Fs, and

ET=1.0, where Ft=Fs

That is, the lower the degree of modifying performed when embedding data into a region of the template, the higher the value calculated from Equation (1) or (2) (the maximum value is 1). Furthermore, let n be the number of image data pieces, Epi (i=1, 2, 3, . . . , n) be the degree of modifying performed when embedding image data into the template, m be the number of text data pieces, and ETj (j=1, 2, 3, . . . , m) be the degree of modifying performed when embedding text data into the template. In this case, the evaluation value E for the generated document is calculated from Equation (3), as a cumulative total of the ratios representing the degrees of modifying performed on the image data and the text data.

$$E = ( {\sum }_{i = 1}^{n} EPi + {\sum }_{j = 1}^{m} ETj ) / ( n + m ) \qquad ( 3 )$$

That is, the higher the evaluation value obtained from Equation (3), the lower the degree of modifying performed when embedding data into a region of the template in the whole document.

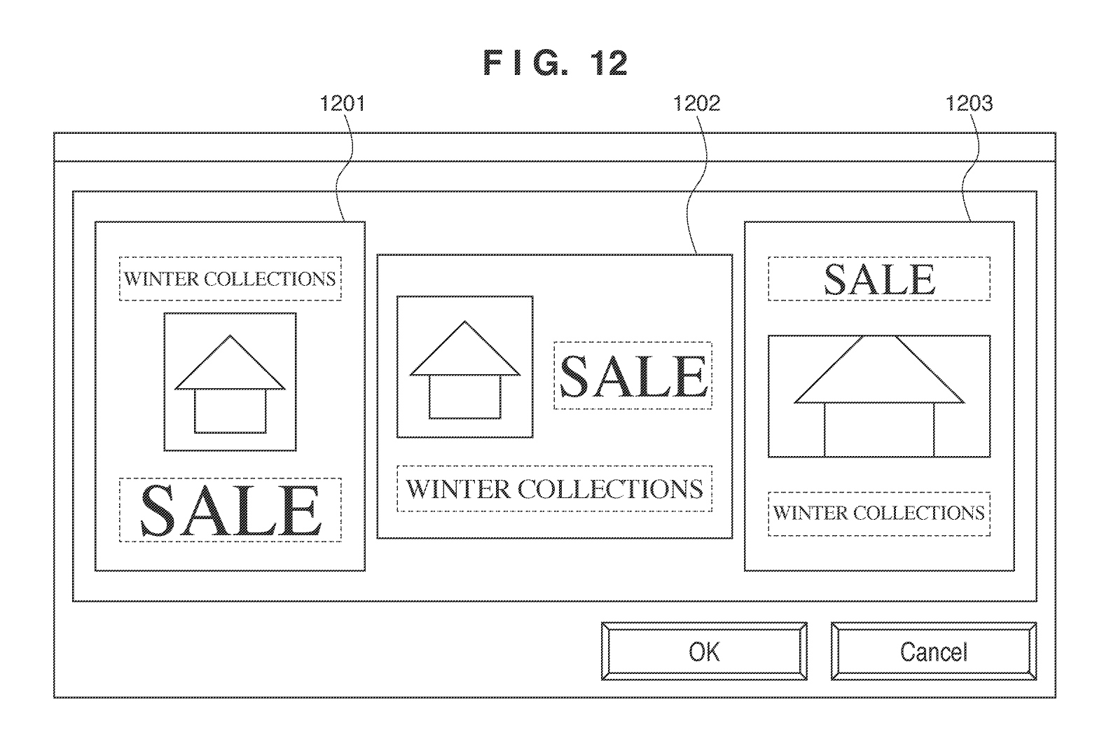

Next is a description of processing for displaying generated documents in a list. The evaluation value is calculated for each of the generated documents in accordance with the flowchart shown in FIG. 3. In the present example, the evaluation value E1 for a generated document 1203 is 0.7, the evaluation value E2 for a generated document 1202 is 0.8, and the evaluation value E3 for a generated document 1201 is 0.9. Those documents are sorted in descending order of their evaluation values and displayed in a list for previewing on the monitor 7 as shown in FIG. 12. As shown in FIG. 12, in the case where objects are embedded into each of multiple types of templates, the document with the highest evaluation value is displayed at the head of the list. Thereafter, the user selects the desired template. As described above, in the present embodiment, the user can select an appropriate template that has the desired layout and can maintain display quality, from the list. The user can then make edits while checking the design in accordance with a predetermined evaluation criterion. Alternatively, the evaluation result of each template may be displayed on a different screen, instead of being displayed in a list. Furthermore, various evaluation methods may be used based on differences between templates.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

Note that the above description has taken the example of the case where the processing as described above is implemented by the CPU executing the programs stored in the auxiliary storage unit. In this case, the number of CPUs is not limited to one, and multiple CPUs may execute the processing in corporation with one another. Furthermore, the programs (or software) implemented by one or more CPUs can also be realized by being supplied to various devices via a network or various types of storage media. Furthermore, part or all of the above-described processing may be executed by dedicated hardware such as an electric circuit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-145523, filed Jun. 25, 2010, which is hereby incorporated by reference herein in its entirety.

What is claimed is:

1. An editing apparatus comprising:
a storage unit configured to store a plurality of templates in each of which a pattern used in editing at least one object and a size of each object are defined;
an object acquiring unit configured to acquire an object targeted for editing;
a template acquiring unit configured to acquire, from the storage unit, a template in which the object acquired by the object acquiring unit is editable;
a determination unit configured to determine whether a size of the object acquired by the object acquiring unit is different from the size defined in the template;
an embedding unit configured to, in a case where the determination unit determines that the size of the object acquired by the object acquiring unit is different from the size defined in the template, modify the object in accordance with the size defined in the template and embed the modified object into the template;
a calculation unit configured to calculate a difference between the size defined in the template and the size of the object acquired by the object acquiring unit, as a consequence of the embedding unit embedding the object into the template; and
an output unit configured to output an evaluation based on the difference calculated by the calculation unit.

2. The editing apparatus according to claim 1, wherein the object has an attribute representing either text data or image data.

3. The editing apparatus according to claim 2, wherein, in a case where the object acquired by the object acquiring unit has an attribute representing text data and the determination unit determines that the size of the object is larger than the size defined in the template, the embedding unit changes a font size of the object so as to embed the object into the template in accordance with the size defined in the template.

4. The editing apparatus according to claim 2, wherein, in a case where the object acquired by the object acquiring unit has an attribute representing image data and the determination unit determines that the size of the object is larger than the size defined in the template, the embedding unit performs trimming processing on the object so as to embed the object into the template in accordance with the size defined in the template.

5. The editing apparatus according to claim 2, further comprising:
a table configured to associate, for each of the plurality of templates, the number of objects having an attribute representing text data in the template, the number of objects having an attribute representing image data in the template, and a storage location of the template,
wherein the template acquiring unit references the table using the number of the objects representing text data and the number of the objects representing image data, the objects being acquired by the object acquiring unit, and acquires a template that corresponds to the numbers of the objects.

6. The editing apparatus according to claim 3, wherein, in a case where the determination unit determined that the size of the object acquired by the object acquiring unit is smaller than or equal to the size defined in the template, the object is embedded into the template with a font size of the object acquired by the object acquiring unit.

7. An editing method performed by an editing apparatus for editing an object using a template, the method comprising:
acquiring an object targeted for editing;
acquiring a template into which the acquired object can be edited, from a memory that stores a plurality of templates in each of which a pattern used in editing an object and a size of each object are defined;
determining whether a size of the acquired object is different from the size defined in the template;
modifying the acquired object in accordance with the size defined in the template and embedding the modified object into the template in a case where it is determined that the size of the acquired object is deferent from the size defined in the template;
calculating a difference between the size defined in the template and the size of the acquired object, as a consequence of the object being embedded into the template; and
outputting an evaluation based on the calculated difference.

8. A non-transitory computer readable storage medium storing a computer executable program, the program comprising:
acquiring an object targeted for editing;
acquiring a template in which the acquired object is editable, from a memory that stores a plurality of templates in each of which a pattern used in editing at least one object and a size of each object are defined;
determining whether a size of the acquired object is different from the size defined in the template;
modifying the object in accordance with the size defined in the template and embedding the modified object into the template in a case where it is determined that the size of the acquired object is different from the size defined in the template;
calculating a difference between the size defined in the template and the size of the acquired object, as a consequence of the object being embedded into the template; and
outputting an evaluation based on the calculated difference.
